(19) United States
(12) Patent Application Publication
(10) Pub. No.: US 2026/0291200 A1
(43) Pub. Date: Sep. 24, 2026

(54) LONG OBJECT GUIDING DEVICE

(71) Applicant: TSUBAKIMOTO CHAIN CO., Osaka-shi, Osaka (JP)

(72) Inventor: Masayuki Ishikawa, Osaka-shi (JP)

(73) Assignee: TSUBAKIMOTO CHAIN CO., Osaka-shi, Osaka (JP)

(21) Appl. No.: 19/119,181

(22) PCT Filed: Sep. 21, 2023
(86) PCT No.: PCT/JP2023/034354

§ 371 Date: Apr. 8, 2025

(30) Foreign Application Priority Data
Oct. 13, 2022 (JP) 2022-164840

(51) Int. Cl. H02G 11/00; F16G 13/16

(52) U.S. Cl. CPC H02G 11/006; F16G 13/16

(57) ABSTRACT

A long object guiding device includes links coupled to each other in series in a lengthwise direction. Each link includes two opposing side plates spaced apart from each other in a widthwise direction. The links are displaceable between a straight state and a curved state. Each side plate of each link includes a contact portion and an impact absorber. The contact portion contacts an adjacent side plate when the links are displaced between the straight state and the curved state. The impact absorber comes into contact with at least one of the adjacent side plate and the contact portion immediately before the contact portion contacts the adjacent side plate and elastically deforms in order to absorb an impact force produced by the contact between the adjacent side plate and the contact portion.

### TECHNICAL FIELD

The present disclosure relates to a long object guiding device that guides a long object, such as a flexible cable for feeling power to or a hose for feeding fluid to a mobile body of a machine tool or the like, while protecting the long object in accordance with movement of the mobile body.

### BACKGROUND ART

Patent Literature 1 discloses a guiding device for a long object. This device includes a number of links sequentially coupled to each other in a state arranged in series. Each of the links includes two opposing side plates spaced apart from each other in a left-right direction, and coupling arms connecting the left and right side plates. The left and right side plates and the coupling arms of the links, which are connected in a series-arrangement direction, form an accommodation space extending in the series-arrangement direction. The long object is accommodated in the accommodation space in the series-arrangement direction.

Each side plate of each of the links includes a side plate front portion, a side plate rear portion, and a bendable joint. The side plate front portion is coupled to a corresponding side plate of a preceding link in the series-arrangement direction. The side plate rear portion is coupled to a corresponding side plate of a trailing link in the series-arrangement direction. The joint is arranged between the side plate front portion and the side plate rear portion. The side plate front portion and the side plate rear portion are both formed from high-rigidity resin. On the other hand, the joint is formed from fatigue-resistant resin that is soft. The joint is integrated with the side plate front portion and the side plate rear portion by two-color molding.

In such a long object guiding device, the links are displaced between a straight state, in which the links are aligned in a straight line, and a curved state, in which the links are aligned in a curved line, in accordance with movement of a mobile body. In this case, the joint deforms and changes the relative position of adjacent links in the series-arrangement direction. Specifically, the deformation of the joint displaces the adjacent links in the series-arrangement direction between a contact state, in which the side plates of the adjacent links are partially in contact with each other, and a separated state, in which the side plates of the adjacent links are separated from each other.

### CITATION LIST

### Patent Literature

Patent Literature 1: Japanese Laid-Open Patent Publication No. 2007-192367

### SUMMARY OF INVENTION

### Technical Problem

In the above long object guiding device, the side plates of the links are formed from high-rigidity resin. Accordingly, when the side plates of the adjacent links approach each other in the series-arrangement direction from the separated state to the contact state in accordance with the deformation of the joint, a relatively large impact force may be applied to the side plates.

### Solution to Problem

A guiding device for a long object in accordance with one general aspect of the present disclosure includes links sequentially coupled to each other in a state arranged in series in a lengthwise direction. Each of the links includes two opposing side plates spaced apart from each other in a widthwise direction that is orthogonal to the lengthwise direction. In a state in which the long object is accommodated in an accommodation space formed between a plurality of the two side plates in the lengthwise direction, the guiding device is configured to be displaceable between a straight state in which the links are aligned in a straight line and a curved state in which the links are aligned in a curved line. Each side plate of each of the links includes a contact portion and an impact absorber. The contact portion contacts an adjacent side plate when the links are displaced between the straight state and the curved state. The adjacent side plate is a corresponding one of the two side plates of an adjacent link in the lengthwise direction. The impact absorber comes into contact with at least one of the adjacent side plate and the contact portion immediately before the contact portion contacts the adjacent side plate and elastically deforms in order to absorb an impact force produced by the contact between the adjacent side plate and the contact portion.

### BRIEF DESCRIPTION OF DRAWINGS

FIG. 1 is a perspective view schematically showing a main part of a long object guiding device in accordance with an embodiment.

FIG. 2 is a perspective view of a side plate of the long object guiding device as viewed from an outer side.

FIG. 3 is a perspective view of the side plate of the long object guiding device as viewed from an inner side.

FIG. 4 is a perspective view showing the side plate coupled to an adjacent side plate as viewed from the outer side.

FIG. 5 is a perspective view showing the side plate coupled to the adjacent side plate as viewed from the inner side.

FIG. 6 is a side view taken along line 6-6 shown in FIG. 1.

FIG. 7 is a cross-sectional side view taken along line 7-7 shown in FIG. 1.

FIG. 8 is a side view enlarging section A encircled by the double-dashed line in FIG. 6.

FIG. 9 is a side view showing a state in which a first contact portion is in contact with a first impact absorber.

FIG. 10 is a side view enlarging section A encircled by the double-dashed line in FIG. 7.

FIG. 11 is a side view showing a state in which the adjacent side plate is in contact with a second impact absorber.

### DESCRIPTION OF EMBODIMENTS

An embodiment of a long object guiding device will now be described with reference to the drawings.

### Long Object Guiding Device

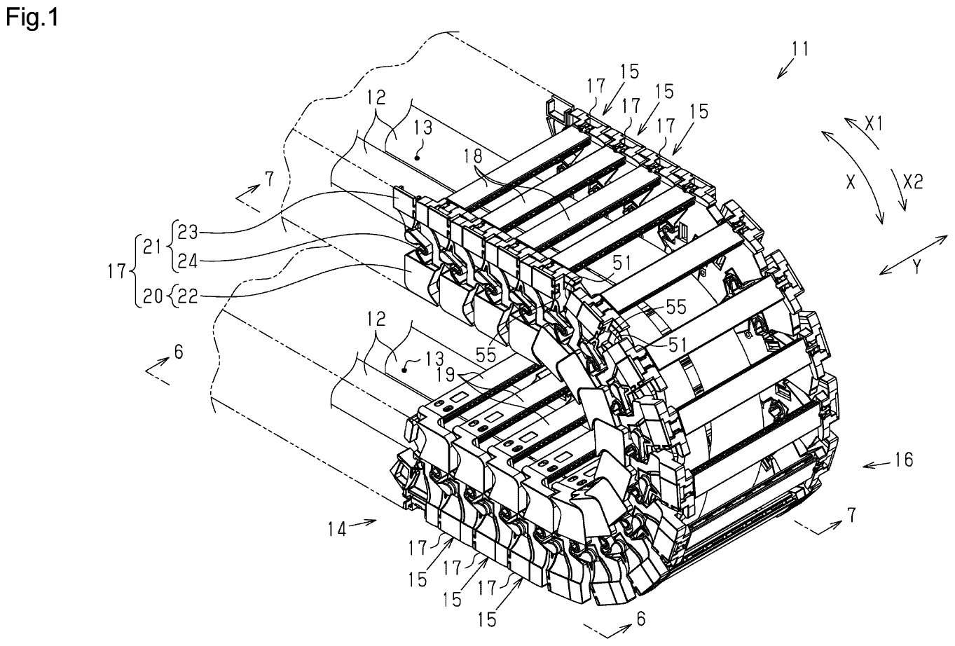

As shown in FIG. 1, a long object guiding device 11 includes a long protective guiding portion 14. The protective guiding portion 14 has an accommodation space 13 at an inner side. The accommodation space 13 is configured to accommodate a flexible long object 12 that is in an extended state. The protective guiding portion 14 is formed by sequentially coupling links 15 that are arranged in series in a lengthwise direction X. When the protective guiding portion 14 is bent at an intermediate part in the lengthwise direction X, the protective guiding portion 14 forms a bent part 16 in which the links 15 are aligned in a curved line. Hereinafter, with respect to the lengthwise direction X, a direction in which the protective guiding portion 14 extends from an upper end of the bent part 16 diagonally upward to the left, as shown in FIG. 1, will be referred to as a first direction X1. Further, a direction opposite to the first direction X1 will be referred to as a second direction X2.

With respect to the lengthwise direction X of the protective guiding portion 14, a mobile body (not shown) is attached to an end of the part of the protective guiding portion 14 extending in the first direction X1 from the upper end of the bent part 16 shown in FIG. 1. The mobile body is configured to be moved back and forth in the lengthwise direction X of the protective guiding portion 14. Furthermore, with respect to the lengthwise direction X of the protective guiding portion 14, an end of a part of the protective guiding portion 14 extending in the second direction X2 from a lower end of the bent part 16 shown in FIG. 1 is fastened to a fastening portion (not shown). The fastening portion is, for example, arranged on a floor surface on which the long object guiding device 11 is installed. When the mobile body is moved and displaces the bent part 16 in either the first direction X1 or the second direction X2, the long object guiding device 11 is configured to be displaceable between a straight state in which the links 15 are aligned in a straight line and a curved state in which the links 15 are aligned in a curved line.

Examples of the long object 12 accommodated in the accommodation space 13 of the protective guiding portion 14 include a cable for feeding power or transmitting signals to the mobile body, a hose for supplying gas, such as air, or liquid, such as oil, to the mobile body, or the like. The long object 12 may be a flexible long member that can be accommodated in the accommodation space 13 inside the protective guiding portion 14 in a state in which the long object 12 extends in the lengthwise direction X of the protective guiding portion 14.

### Link

Each of the links 15 includes two side plates 17, a first arm 18, and a second arm 19. The side plates 17 are spaced apart from each other in a widthwise direction Y that is orthogonal to the lengthwise direction X of the protective guiding portion 14. The first arm 18 and the second arm 19 are each belt-shaped and arranged between the two opposing side plates 17. The first arm 18 connects the two opposing side plates 17 at an outer circumferential side of the bent part 16. The second arm 19 connects the two opposing side plates 17 at an inner circumferential side of the bent part 16. A plurality of opposing side plates 17, first arms 18, and the second arms 19 define the accommodation space 13 that extends in the lengthwise direction X of the protective guiding portion 14. The accommodation space 13 allows for accommodation of the long object 12 that is in an extended state.

### Side Plate

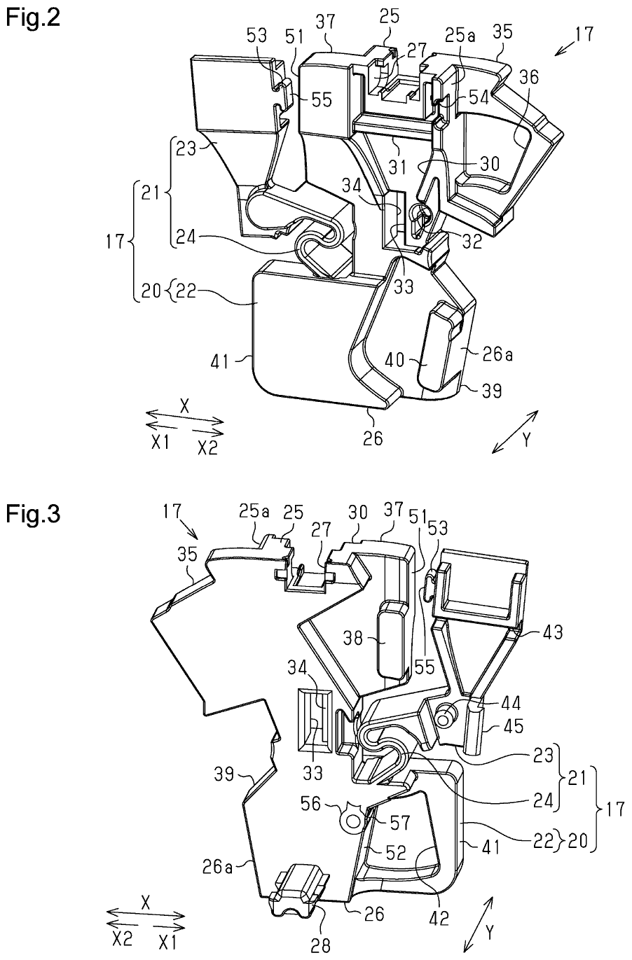

As shown in FIGS. 2 and 3, each side plate 17 is formed by two-color molding in which a hard portion 20 and a soft portion 21 are integrated with each other. The hard portion 20 is formed from a hard resin molding material and has a relatively high rigidity. The soft portion 21 is formed from a soft resin molding material. The hard resin may include, for example, glass fiber-reinforced resin, carbon fiber-reinforced resin, polyamide, or the like. The soft resin may include, for example, non-reinforced resin, elastomer, polyamide, or the like. The soft resin is softer than the hard resin and has a toughness that withstands repeated bending. FIG. 2 shows an outer side surface of the side plate 17 exposed to the outside of the protective guiding portion 14. FIG. 3 shows an inner side surface of the side plate 17 facing the accommodation space 13 inside the protective guiding portion 14.

Each side plate 17 includes a side plate main body 22, a side plate coupling portion 23, and a flexible portion 24. The side plate main body 22 is plate-shaped. The side plate coupling portion 23 is smaller than the side plate main body 22. The flexible portion 24 is deformable between the side plate main body 22 and the side plate coupling portion 23, and is integrated with the side plate main body 22 and the side plate coupling portion 23. The side plate main body 22 is formed by the hard portion 20, which is formed from a hard resin molding material. Accordingly, the side plate main body 22 has a relatively high rigidity. In contrast, the side plate coupling portion 23 and the flexible portion 24 are formed by the soft portion 21, which is formed from a soft resin molding material. Accordingly, the side plate coupling portion 23 and the flexible portion 24 are elastically deformable. The side plate 17 includes the side plate main body 22, the side plate coupling portion 23, and the flexible portion 24 that are integrated with one another by two-color molding that uses the hard resin and the soft resin.

### Side Plate Main Body

As shown in FIGS. 2 and 3, the side plate main body 22 includes a first side plate portion 25 and a second side plate portion 26. When the side plate 17 is located in the bent part 16, the first side plate portion 25 is located at the outer circumferential side of the bent part 16, and the second side plate portion 26 is located at the inner circumferential side of the bent part 16. A fitting slot 27 is formed in an end surface of the first side plate portion 25 located at the outer circumferential side of the bent part 16. The fitting slot 27 receives an end of the first arm 18. As shown in FIG. 3, a cantilever 28 is arranged on an inner side surface of the second side plate portion 26 at a part proximate to the inner circumference. The cantilever 28 extends horizontally in the widthwise direction Y of the link 15. The cantilever 28 is configured to support the second arm 19 in a connected state.

The side plate 17 shown in FIGS. 2 and 3 opposes another side plate 17 in the widthwise direction Y of the link 15. The other side plate 17 also includes a cantilever 28, which is arranged on the inner side surface of the second side plate portion 26 and extends in the horizontal direction. The ends of the first arm 18 are fitted to the fitting slots 27 of the two opposing side plates 17, and the second arm 19 is arranged between the two cantilevers 28. In this state, the side plates 17, the first arm 18, and the second arm 19 form part of the accommodation space 13.

### First Side Plate Portion

As shown in FIG. 2, a fitting recess 30 is formed in an outer side surface of the first side plate portion 25 at a substantially central location. The fitting recess 30 is configured to receive the side plate coupling portion 23 of the side plate 17 of an adjacent link 15 in the lengthwise direction X. The fitting recess 30 is connected to the fitting slot 27 through an edge portion of the fitting recess 30 located at the outer circumferential side, which is the upper side in FIG. 2. Further, the fitting recess 30 includes an engagement portion 31 that has the form of a straight wall. The engagement portion 31 is located slightly lower than the portion where the fitting recess 30 is continuous with the fitting slot 27 in FIG. 2. Furthermore, the fitting recess 30 includes an insertion opening 32 and an engagement hole 33. The insertion opening 32 and the engagement hole 33 are arranged horizontally next to each other, and are located lower than the engagement portion 31 in FIG. 2. The insertion opening 32 is partially arcuate. The engagement hole 33 is rectangular. As shown in FIG. 3, the engagement hole 33 includes an engagement step 34. The engagement step 34 is arranged on an inner wall of the engagement hole 33, and is located at an intermediate part of the first side plate portion 25 in a thickness-wise direction.

The first side plate portion 25 includes a part that extends from the fitting recess 30 in the second direction X2. This part is defined as a second direction side first thin portion 35. The second direction side first thin portion 35 has a plate thickness extending from an intermediate part of the first side plate portion 25 in the widthwise direction Y to the inner side surface of the first side plate portion 25, which is located at the far side in FIG. 2. A first engagement recess 36 is formed in the outer side surface of the second direction side first thin portion 35, which is located at the near side in FIG. 2. The near side faces the viewer of the drawing. The first engagement recess 36 is substantially sectoral. Furthermore, the first side plate portion 25 includes a part that extends from the fitting recess 30 in the first direction X1. This part is defined as a first direction side first thin portion 37. The first direction side first thin portion 37 has a plate thickness extending from an intermediate part of the first side plate portion 25 in the widthwise direction Y to the outer side surface of the first side plate portion 25, which is located at the far side in FIG. 3. A first engagement projection 38 is formed on the inner side surface of the first direction side first thin portion 37, which is located at the near side in FIG. 3. The first engagement projection 38 extends along an edge of the first direction side first thin portion 37 located at a side facing the first direction X1.

### Second Side Plate Portion

As shown in FIGS. 2 and 3, the second side plate portion 26 includes a part that extends in the second direction X2 from an intermediate part of the second side plate portion 26 in the lengthwise direction X. This part is defined as a second direction side second thin portion 39. The second direction side second thin portion 39 is a part where the cantilever 28 is formed on the inner side surface. The second direction side second thin portion 39 has a plate thickness extending from an intermediate part of the second side plate portion 26 in the widthwise direction Y to the inner side surface of the second side plate portion 26, which is located at the far side in FIG. 2. A second engagement projection 40 is formed on the outer side surface of the second direction side second thin portion 39, which is located at the near side in FIG. 2. The second engagement projection 40 extends along an edge of the second direction side second thin portion 39 located at a side facing the second direction X2. Furthermore, the second side plate portion 26 includes a part that extends in the first direction X1 from an intermediate part of the second side plate portion 26 in the lengthwise direction X. This part is defined as a first direction side second thin portion 41. The first direction side second thin portion 41 has a plate thickness extending from an intermediate part of the second side plate portion 26 in the widthwise direction Y to the outer surface of the second side plate portion 26, which is located at the far side in FIG. 3. A second engagement recess 42 formed in the inner side surface of the first direction side second thin portion 41, which is located at the near side in FIG. 3. The second engagement recess is substantially sectoral.

### Side Plate Coupling Portion

As shown in FIGS. 2 and 3, the outer shape of the side plate coupling portion 23, as viewed in the widthwise direction Y, conforms to the shape of the fitting recess 30 formed in the outer side surface of the first side plate portion 25 of the side plate main body 22. An engagement groove 43 is formed in the inner surface of the side plate coupling portion 23, which is located at the near side in FIG. 3. The engagement groove 43 is configured to engage with the straight wall-shaped engagement portion 31, which is arranged in the fitting recess 30 of the first side plate portion 25. Furthermore, an insertion shaft 44 and an engagement claw 45 are arranged on the inner side surface of the side plate coupling portion 23. The insertion shaft 44 and the engagement claw 45 are located lower than the engagement groove 43 in FIG. 3. The insertion shaft 44 is inserted into the insertion opening 32 arranged in the fitting recess 30 of the first side plate portion 25. The engagement claw 45 is inserted into the engagement hole 33, and is engageable with the engagement step 34.

### Flexible Portion

As shown in FIGS. 2 and 3, the flexible portion 24 is S-shaped as viewed in the widthwise direction Y. The flexible portion 24 includes a distal end and a basal end. The distal end of the flexible portion 24 corresponds to the upper end of the flexible portion 24 shown in FIGS. 2 and 3. The distal end of the flexible portion 24 is integrated with a basal end of the side plate coupling portion 23. The basal end of the flexible portion 24 corresponds to the lower end of the flexible portion 24 shown in FIGS. 2 and 3. The basal end of the flexible portion 24 is integrated with the second side plate portion 26 of the side plate main body 22. Specifically, the basal end of the flexible portion 24 is integrated with the upper edge of the second side plate portion 26 shown in FIGS. 2 and 3, at a position corresponding to the boundary between the first direction side second thin portion 41 and the second direction side second thin portion 39.

### Adjacent Side Plate

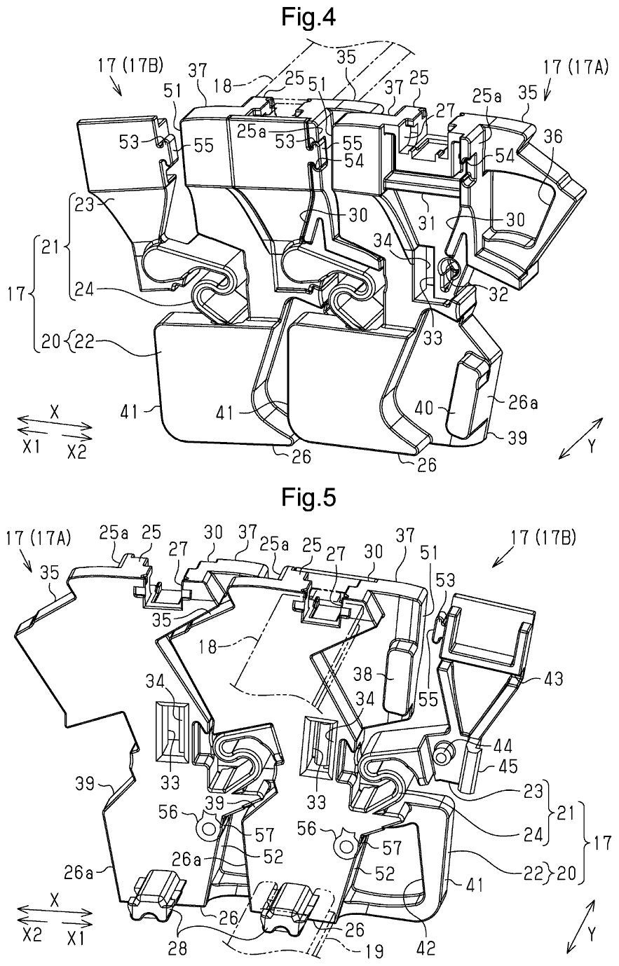

As shown in FIGS. 4 and 5, when the side plate coupling portion 23 of a reference side plate 17A, which is the side plate 17 of one of two adjacent links 15, is engaged with the side plate main body 22 of an adjacent side plate 17B, which is the side plate 17 of the other one of the two adjacent links 15, the side plates 17 of the two adjacent links 15 in the lengthwise direction X are coupled to each other. In other words, when the side plate coupling portion 23 of the reference side plate 17 (17A), which is located at a side facing the second direction X2, is fitted to the fitting recess 30 of the side plate main body 22 of the adjacent side plate 17 (17B), which is located at a side facing the first direction X1, the side plates 17 of the adjacent links 15 in the lengthwise direction X are coupled to each other. That is, the two side plates 17 of the link 15 are coupled to the side plates 17 (adjacent side plates 17B) of the adjacent link 15, respectively. In this state, as indicated by the double-dashed lines in FIGS. 4 and 5, the first arms 18 and the second arms 19 are arranged between the opposing side plates 17 in the widthwise direction Y. This forms the long protective guiding portion 14 that has the accommodation space 13 for the long object 12 inside.

### Contact Portion

In the state shown in FIGS. 4 and 5, the reference side plate 17A located at a side facing the second direction X2 is separated from the adjacent side plate 17B located at a side facing the first direction X1, such that the side surfaces of the side plate main bodies 22 of the two adjacent side plates 17 do not contact each other. When the flexible portion 24 deforms from the state shown in FIGS. 4 and 5, the first side plate portion 25 located at the outer circumferential side and the second side plate portion 26 located at the inner circumferential side move relative to each other toward opposite sides with respect to the lengthwise direction X. In this case, the reference side plate 17A located at a side facing the second direction X2 comes into contact with the adjacent side plate 17B located at a side facing the first direction X1. In other words, when the links 15 are displaced between the straight state, in which the links 15 are aligned in a straight line, and the curved state, in which the links 15 are aligned in a curved line, the side plate main body 22 of the reference side plate 17A, which is located at a side facing the second direction X2, comes into contact with the adjacent side plate 17B located at a side facing the first direction X1.

Specifically, when the links 15, which are coupled to each other in the lengthwise direction X, are displaced from the curved state to the straight state, the first side plate portion 25 of the side plate main body 22 of the reference side plate 17A, which is located at a side facing the second direction X2, comes into contact with the adjacent side plate 17B located at a side facing the first direction X1. More specifically, a first contact portion 51 of the reference side plate 17A comes into contact with a side surface 25a of the adjacent side plate 17B. The first contact portion 51 is formed by a side surface of the first direction side first thin portion 37 of the first side plate portion 25 of the reference side plate 17A, and faces the first direction X1. The side surface 25a is located on the first side plate portion 25 of the adjacent side plate 17B of the link 15, which is adjacent to the reference side plate 17A in the lengthwise direction X, and faces the second direction X2.

In contrast, when the links 15, which are coupled to each other in the lengthwise direction X, are displaced from the straight state to the curved state, the second side plate portion 26 of the side plate main body 22 of the reference side plate 17A, which is located at a side facing the second direction X2, comes into contact with the adjacent side plate 17B located at a side facing the first direction X1. More specifically, a second contact portion 52 of the reference side plate 17A comes into contact with a side surface 26a of the adjacent side plate 17B. The second contact portion 52 is formed by a side surface of the first direction side second thin portion 41 of the second side plate portion 26 of the reference side plate 17A, and faces the first direction X1. The side surface 26a is located on the second side plate portion 26 of the adjacent side plate 17B of the link 15, which is adjacent to the reference side plate 17A in the lengthwise direction X, and faces the second direction X2.

### Impact Absorber

As shown in FIGS. 2 to 5, each side plate 17 includes a protrusion 53 arranged on a side surface of the side plate coupling portion 23 that faces the second direction X2. The protrusion 53 is substantially T-shaped as viewed in the widthwise direction Y. The protrusion 53 protrudes toward the first contact portion 51 in the second direction X2. Furthermore, each side plate 17 includes a cutout recess 54 formed in a side surface of the first side plate portion 25 that faces the second direction X2. The cutout recess 54 is continuous with the fitting recess 30. The cutout recess 54 is configured to receive the protrusion 53 fitted from the outer side with respect to the widthwise direction Y.

In a state in which the protrusion 53 is fitted to the cutout recess 54, a surface of the protrusion 53 facing the second direction X2 protrudes from the side surface 25a of the first side plate portion 25 toward the first contact portion 51. The protrusion 53 is a part of the side plate coupling portion 23, which is formed by the soft portion 21. Accordingly, the protrusion 53 is elastically deformable. In the present embodiment, the surface of the elastically deformable protrusion 53 protruding in the second direction X2 forms a first impact absorber 55. The first impact absorber 55 is configured to absorb an impact force produced when the first side plate portions 25 of adjacent side plates 17 come into contact with each other.

The second side plate portion 26 includes a tubular portion 56. The tubular portion 56 is formed by the elastically deformable soft portion 21, in the same manner as the flexible portion 24. The tubular portion 56 is integrated with the second side plate portion 26, such that the outer circumferential surface of the tubular portion 56 is partially exposed from the second contact portion 52. The part of the outer circumferential surface of the tubular portion 56 exposed from the second contact portion 52 in the first direction X1 protrudes toward the side surface 26a of the second side plate portion 26 of the adjacent side plate 17B, which is located at a side facing the first direction X1. In the present embodiment, the part of the outer circumferential surface of the elastically deformable tubular portion 56 protruding from the second contact portion 52 in the first direction X1 forms a second impact absorber 57. The second impact absorber 57 is configured to absorb an impact force produced when the second side plate portions 26 of adjacent side plates 17 come into contact with each other.

### Operation

The operation of the long object guiding device 11 in accordance with the present embodiment will now be described.

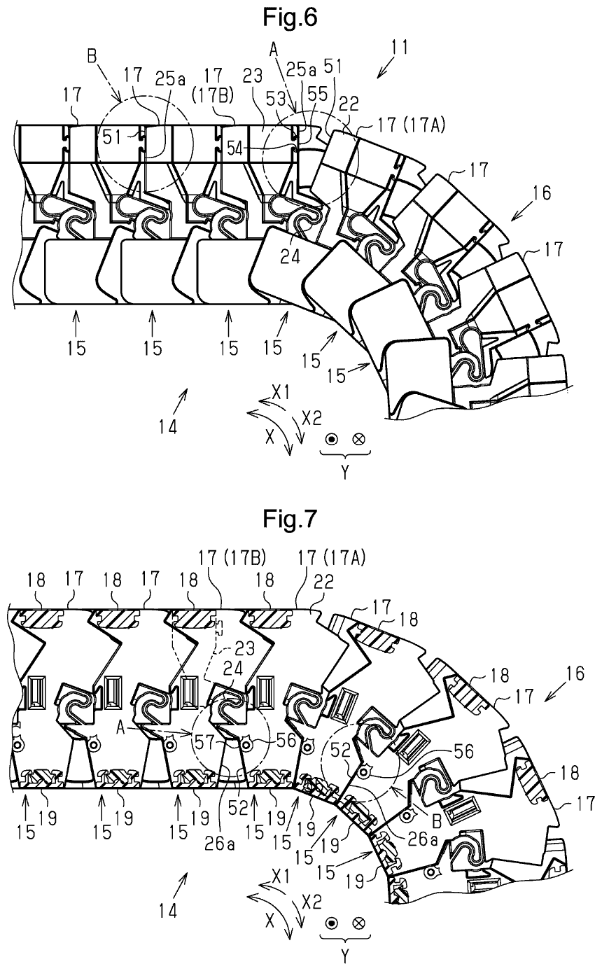

As shown in FIGS. 6 and 7, in the bent part 16, the links 15 of the protective guiding portion 14 of the long object guiding device 11 are in the curved state. When the mobile body (not shown) is moved in the first direction X1, the bent part 16 is also moved in the first direction X1. In this case, the links 15 in the curved state in the bent part 16 are pivoted in the counterclockwise direction in FIGS. 6 and 7, and shifted to the straight state.

In contrast, when the mobile body (not shown) is moved in the second direction X2 from the state shown in FIGS. 6 and 7, the bent part 16 is also moved in the second direction X2. In this case, the links 15 in the straight state located at a side of the bent part 16 in the first direction X1 sequentially reach the bent part 16. These links 15 are pivoted in the clockwise direction in FIGS. 6 and 7, and shifted to the curved state.

When the links 15 are displaced between the straight state and the curved state, the side plates 17 of adjacent links 15 in the lengthwise direction X are moved relative to each other. Hereinafter, the manner in which the side plates 17 are displaced will be described. In other words, when the adjacent links 15 are moved in the lengthwise direction X, the adjacent side plate 17B, which is the side plate 17 located at a side facing the first direction X1, and the reference side plate 17A, which is the side plate 17 located at a side facing the second direction X2, are displaced between a contact state and a separated state. The following description focuses on the manner in which the side plates 17 are displaced.

### Contact State and Separated State

As shown in section A encircled by the double-dashed line in FIG. 6, when the reference side plate 17A located at a side facing the second direction X2 is in the bent part 16, the reference side plate 17A is in a separated state, in which the first contact portion 51 of the reference side plate 17A at the outer circumferential side is separated from the side surface 25a of the adjacent side plate 17B, which is located at a side facing the first direction X1. In contrast, as shown in section B encircled by the double-dashed line in FIG. 7, in this state, the side plate 17 located at a side facing the second direction X2 is in a contact state, in which the second contact portion 52 of the side plate 17 at the inner circumferential side is in contact with the side surface 26a of the side plate 17, which is located at a side facing the first direction X1.

Then, when the mobile body (not shown) is moved in the first direction X1 from the above state, the side plates 17, including the reference side plate 17A and the adjacent side plate 17B, are shifted to the straight state. In this case, the reference side plate 17A is displaced in the following manner. As shown in section B encircled by the double-dashed line in FIG. 6, the side plate 17 located at a side facing the second direction X2 is shifted to a contact state, in which the first contact portion 51 of the side plate 17 at the outer circumferential side is in contact with the side surface 25a of the side plate 17, which is located at a side facing the first direction X1. In contrast, as shown in section A encircled by the double-dashed line in FIG. 7, in this state, the side plate 17 located at a side facing the second direction X2 is shifted to a separated state, in which the second contact portion 52 of the side plate 17 at the inner circumferential side is separated from the side surface 26a of the side plate 17, which is located at a side facing the first direction X1.

When the mobile body (not shown) is moved in the second direction X2, which is opposite to the case described above, the reference side plate 17A and the adjacent side plate 17B in the straight state are moved in the second direction X2, and reach the bent part 16. In this case, the reference side plate 17A is displaced in the following manner. As shown in section A encircled by the double-dashed line in FIG. 6, the reference side plate 17A located at a side facing the second direction X2 is shifted to a separated state, in which the first contact portion 51 of the reference side plate 17A at the outer peripheral side is separated from the side surface 25a of the adjacent side plate 17B facing the second direction X2. In contrast, as shown in section B encircled by the double-dashed line in FIG. 7, in this state, the side plate 17 located at a side facing the second direction X2 is shifted to a contact state, in which the second contact portion 52 of the side plate 17 at the inner circumferential side is in contact with the side surface 26a of the side plate 17, which is located at a side facing the first direction X1.

### Impact Force Absorption

When the first contact portion 51 and the second contact portion 52 of the reference side plate 17A come into contact with the side surface 25a of the first side plate portion 25 and the side surface 26a of the second side plate portion 26 of the adjacent side plate 17B, respectively, a large impact force will be applied to the two side plates 17. Particularly, the side plate main body 22, which includes the first contact portion 51, the second contact portion 52, the side surface 25a of the first side plate portion 25, and the side surface 26a of the second side plate portion 26, is formed by the hard portion 20 that has a relatively high rigidity. This may also produce a large collision noise. In this regard, the present embodiment includes the first impact absorber 55 and the second impact absorber 57 that are elastically deformable, so as to reduce the impact force and the collision noise.

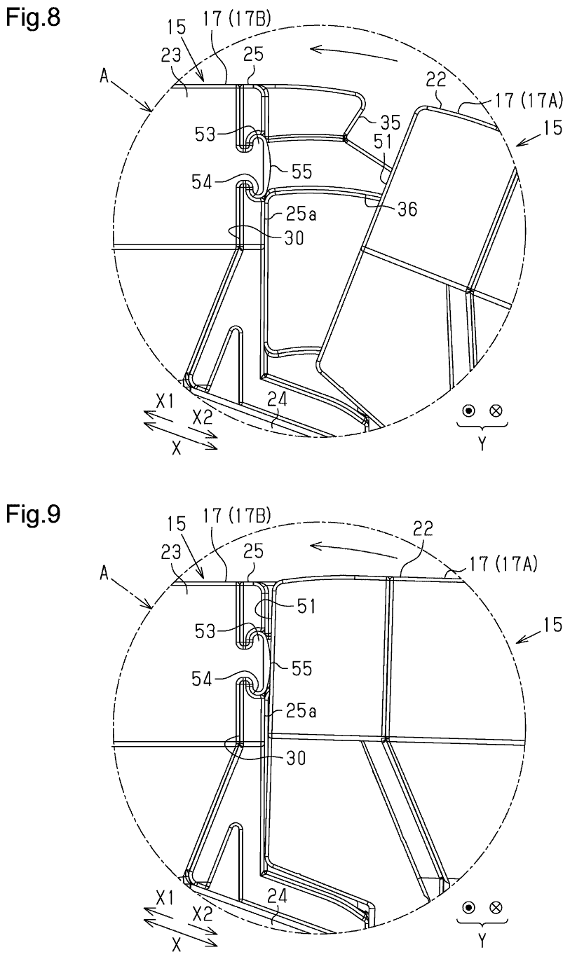

First, the reference side plate 17A is pivoted in the direction indicated by the arrow in FIG. 8 from a state in which the first contact portion 51 is separated from the side surface 25a of the adjacent side plate 17B. In this case, as shown in FIG. 9, the first contact portion 51 comes into contact with the first impact absorber 55, which is a protrusion. Specifically, the first contact portion 51 comes into contact with the first impact absorber 55, which protrudes from the side surface 25a toward the first contact portion 51 in the second direction X2, with an impact force immediately before the first contact portion 51 contacts the side surface 25a of the adjacent side plate 17B. This elastically deforms the first impact absorber 55, which is formed by the soft portion 21, such that the first impact absorber 55 contracts. The elastic deformation of the first impact absorber 55 reduces a speed at which the reference side plate 17A is pivoted in the counterclockwise direction. As a result, as shown in section B encircled by the double-dashed line in FIG. 6, a colliding speed at which the first contact portion 51 comes into contact with the side surface 25a of the adjacent side plate 17B is reduced, thereby reducing the impact force produced by the contact.

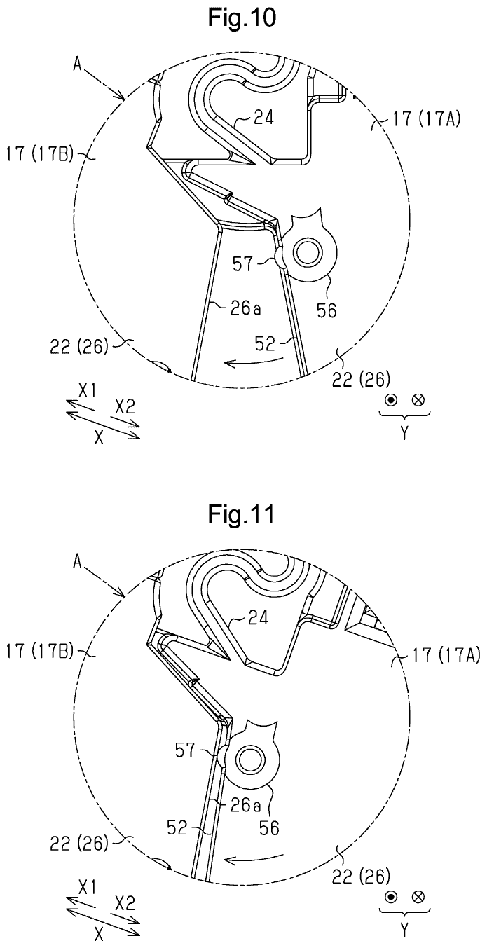

In contrast, the reference side plate 17A is pivoted in the direction indicated by the arrow in FIG. 10 from a state in which the second contact portion 52 is separated from the side surface 26a of the adjacent side plate 17B. In this case, as shown in FIG. 11, the second impact absorber 57 comes into contact with the side surface 26a of the adjacent side plate 17B. Specifically, the second contact portion 52 comes into contact with the second impact absorber 57, which protrudes from the second contact portion 52 toward the side surface 26a in the first direction X1, with an impact force immediately before the second contact portion 52 contacts the side surface 26a of the adjacent side plate 17B. This elastically deforms the second impact absorber 57, which is formed by the soft portion 21, such that the second impact absorber 57 contracts. The elastic deformation of the second impact absorber 57 reduces a speed at which the reference side plate 17A is pivoted in the clockwise direction.

As a result, as shown in section B encircled by the double-dashed line in FIG. 7, a colliding speed at which the second contact portion 52 comes into contact with the side surface 26a of the adjacent side plate 17B is reduced, thereby reducing the impact force produced by the contact.

### Advantages

(1) When the links 15 are displaced from the curved state to the straight state, the first impact absorber 55 comes into contact with the first contact portion 51 immediately before the first contact portion 51 of the side plate 17 contacts the adjacent side plate 17B, which is adjacent to the side plate 17 in the first direction X1. In contrast, when the links 15 are displaced from the straight state to the curved state, the second impact absorber 57 comes into contact with the adjacent side plate 17B immediately before the second contact portion 52 of the side plate 17 contacts the adjacent side plate 17, which is adjacent to the side plate 17 in the first direction X1. The first impact absorber 55 and the second impact absorber 57 are elastically deformed in accordance with these contacts, so that a speed at which the links 15 are displaced in a direction in which the adjacent side plate 17B comes into contact with the first contact portion 51 or the second contact portion 52 is reduced. This reduces a colliding speed at which the adjacent side plate 17B comes into contact with the first contact portion 51 or the second contact portion 52 immediately after the elastic deformation, thereby reducing the impact force produced by the contact.

(2) The side plate 17 is readily formed by two-color molding using hard resin and soft resin. In the side plate 17, the hard portion 20 and the soft portion 21 are integrated with each other. The hard portion 20 includes the first contact portion 51 and the second contact portion 52, and the soft portion 21 includes the first impact absorber 55 and the second impact absorber 57.

(3) The side plate main body 22 is formed by the hard portion 20. This avoids deformation of the side plate 17 by an external force. Further, the side plate coupling portion 23 is formed by the soft portion 21, and is elastically deformed when coupling adjacent links 15 in the first direction X1. This facilitates the coupling operation. In addition, the side plate coupling portion 23 and the flexible portion 24 are readily molded integrally with each other using the same soft resin.

(4) The first impact absorber 55 and the second impact absorber 57 are readily formed as protruded parts of the side plate 17.

(5) The first impact absorber 55 is arranged at the outer circumferential side, and the second impact absorber 57 is arranged at the inner circumferential side. This reduces impact forces produced by contacts between adjacent side plates 17 in accordance with displacement of the links 15 between the straight state and the curved state.

### Modified Examples

The above embodiment may be modified as follows. The structure of above embodiment may be combined with any of the following modifications. Also, the following modifications can be combined with one another.

The side plate 17 may include only one of the first impact absorber 55 and the second impact absorber 57. For example, the side plate 17 does not include the second impact absorber 57, and includes only the first impact absorber 55 arranged on the side plate coupling portion 23. This reduces an impact force produced by a contact between adjacent side plates 17 in accordance with displacement of the links 15 from the curved state to the straight state. For another example, the side plate 17 does not include the first impact absorber 55, and includes only the second impact absorber 57 arranged on the second side plate portion 26 at the inner circumferential side. This reduces an impact force produced by a contact between adjacent side plates 17 in accordance with displacement of the links 15 from the straight state to the curved state.

The first impact absorber 55 does not have to be arranged on the surface of the protrusion 53 protruding from the side plate coupling portion 23 in the second direction X2. Alternatively, the first impact absorber 55 may be arranged on the adjacent side plate 17B, which is the side plate 17 of the link 15 having the cutout recess 54 for the protrusion 53. Specifically, the first impact absorber 55 may protrude in the second direction X2 from the side surface 25a of the first side plate portion 25 of the side plate main body 22 of the adjacent side plate 17B.

The first impact absorber 55 does not have to be arranged on the surface of the protrusion 53 protruding from the side plate coupling portion 23 in the second direction X2. Alternatively, the first impact absorber 55 may protrude in the first direction X1 from the first contact portion 51 of the side plate main body 22, which faces the surface of the protrusion 53. The first impact absorber 55 may be arranged on both the first contact portion 51 and the surface of the protrusion 53 facing the second direction X2.

The second impact absorber 57 does not have to be part of the outer circumferential surface of the tubular portion 56 exposed from the second contact portion 52 in the first direction X1. The tubular portion 56 is largely embedded in the second side plate portion 26. Alternatively, the second impact absorber 57 may be part of the second contact portion 52 of the side plate main body 22 and protrude in the first direction X1.

The second impact absorber 57 does not have to protrude from the second contact portion 52 in the first direction X1. Alternatively, the second impact absorber 57 may be arranged on the adjacent side plate 17B, which is the side plate 17 of the link 15 facing the second contact portion 52. Specifically, the second impact absorber 57 may protrude in the second direction X2 from the side surface 26a of the second side plate portion 26 of the side plate main body 22 of the adjacent side plate 17B. The second impact absorber 57 may be arranged on both the second contact portion 52 and the side surface 26a of the second side plate portion 26 facing the second direction X2. In the same manner as the first impact absorber 55, for example, the second impact absorber 57 may be arranged on the side plate 17 such that the second impact absorber 57 comes into contact with the second contact portion 52 immediately before the side surface 26a of the adjacent side plate 17B, which is adjacent to the side plate 17, contacts the second contact portion 52. Alternatively, in addition to the second impact absorber 57, the side plate 17 may include another second impact absorber 57 arranged on the second contact portion 52. The second impact absorber 57 may come into contact with the side surface 26a of the adjacent side plate 17B immediately before the side surface 26a contacts the second contact portion 52.

The side plate main body 22, the side plate coupling portion 23, and the flexible portion 24 of the side plate 17 do not have to be molded integrally with one another, and may be molded separately and coupled to one another afterwards.

The side plate coupling portion 23 may be formed by the hard portion 20, in the same manner as the side plate main body 22. In this case, it is preferred that both the first impact absorber 55 and the protrusion 53 protruding from the side plate coupling portion 23 in the second direction X2 are formed by the soft portion 21, which is formed from soft resin. Alternatively, only the first impact absorber 55 may be formed by the soft portion 21.

At least one of the first impact absorber 55 and the second impact absorber 57 may be arranged on a member other than the side plate 17, for example, at least one of the first arm 18 and the second arm 19. Such an impact absorber may have an elastically deformable distal end that extends downwardly between adjacent side plates 17.

1. A guiding device for a long object, the guiding device comprising:
links sequentially coupled to each other in a state arranged in series in a lengthwise direction, wherein:
each of the links includes two opposing side plates spaced apart from each other in a widthwise direction that is orthogonal to the lengthwise direction;
in a state in which the long object is accommodated in an accommodation space formed between a plurality of the two side plates in the lengthwise direction, the guiding device is configured to be displaceable between a straight state in which the links are aligned in a straight line and a curved state in which the links are aligned in a curved line; and
each side plate of each of the links includes
a contact portion that contacts an adjacent side plate when the links are displaced between the straight state and the curved state, the adjacent side plate being a corresponding one of the two side plates of an adjacent link in the lengthwise direction, and
an impact absorber that comes into contact with at least one of the adjacent side plate and the contact portion immediately before the contact portion contacts the adjacent side plate and elastically deforms in order to absorb an impact force produced by the contact between the adjacent side plate and the contact portion.

2. The guiding device according to claim 1, wherein:
each side plate of each of the links is formed by two-color molding in which a hard portion and a soft portion are integrated with each other, the hard portion being formed from a hard resin molding material and having a relatively high rigidity, and the soft portion being formed from a soft resin molding material and being elastically deformable;
the contact portion is arranged in the hard portion; and
the impact absorber is arranged in the soft portion.

3. The guiding device according to claim 2, wherein:
each side plate of each of the links includes
a side plate main body,
a side plate coupling portion coupled to the side plate main body of the adjacent side plate, and
a flexible portion being deformable between the side plate main body and the side plate coupling portion and integrated with the side plate main body and the side plate coupling portion;
the side plate main body is formed by the hard portion; and
the side plate coupling portion and the flexible portion are formed by the soft portion.

4. The guiding device according to claim 1, wherein the impact absorber is arranged on a part of the side plate such that, in a state in the links are coupled to each other in the lengthwise direction, the impact absorber protrudes from at least one of the contact portion of the side plate and the adjacent side plate toward the other one of the contact portion of the side plate and the adjacent side plate.

5. The guiding device according to claim 1, wherein
the impact absorber includes at least one of a first impact absorber and a second impact absorber,
the first impact absorber comes into contact with at least one of the adjacent side plate and the contact portion immediately before the contact portion contacts the adjacent side plate when the links are displaced from the curved state to the straight state, and
the second impact absorber comes into contact with at least one of the adjacent side plate and the contact portion immediately before the contact portion contacts the adjacent side plate when the links are displaced from the straight state to the curved state.
